(19) United States
(12) Patent Application Publication
(10) Pub. No.: US 2019/0329351 A1
(43) Pub. Date: Oct. 31, 2019

(54) LASER DEFLECTION DEVICE AND LASER MACHINING APPARATUS

(71) Applicant: MITSUBISHI HEAVY INDUSTRIES, LTD., Tokyo (JP)

(72) Inventor: Saneyuki GOYA, Tokyo (JP)

(21) Appl. No.: 16/394,619

(22) Filed: Apr. 25, 2019

(30) Foreign Application Priority Data
Apr. 27, 2018 (JP) 2018-087195

(51) Int. Cl. B23K 26/06; G02F 1/29; H01S 3/00; G02B 27/09; G02B 3/04; G02B 3/06; B23K 26/36

(52) U.S. Cl. CPC B23K 26/0648; G02F 1/29; H01S 3/0071; G02B 27/0955; G02F 2001/291; G02B 3/06; B23K 26/36; G02F 2203/24; G02B 3/04

(57) ABSTRACT

A laser beam deflecting device includes an electro-optic deflector including an electro-optic crystal provided along an optical path of a laser beam, and electrodes for applying a voltage to the electro-optic crystal in a predetermined application direction; and a correction optical system provided downstream of the electro-optic deflector in a radiation direction of the laser beam to correct a beam diameter of the laser beam deflected in the application direction. The radiation direction of the laser beam without being deflected, with no voltage applied by the electrodes, serves as a reference optical axis. The correction optical system serves as an optical system for correcting the beam diameter, at least in the application direction, correspondingly to a distortion in the beam diameter that is dependent on a deflection angle that is formed by the laser beam deflected by the electro-optic deflector and the reference optical axis.

### CROSS-REFERENCE TO RELATED APPLICATIONS

The present application claims priority to and incorporates by reference the entire contents of Japanese Patent Application No. 2018-087195 filed in Japan on Apr. 27, 2018.

### FIELD

The present invention relates to a laser beam deflecting device for deflecting a laser beam, and a laser beam machining apparatus.

### BACKGROUND

An optical deflecting device using an electro-optic effect has been conventionally known (NTT-AT, “KTN Optical Scanner”, [online], [retrieved on 2018, Apr. 23], Retrieved from <http://keytech.ntt-at.co.jp/ktn_crystal/prd_2049.html>, and NTT, “New Development of Highly Stable Light Source for Thickness Measurement Instrument, with Application of Wavelength Varying Technology Using KTN Crystal”, 24 Jan. 2017, [online], [retrieved on 2018, Apr. 23], Retrieved from <http://www.ntt.co.jp/news2017/1701/170124a.html>, for example). Suppression of a beam distortion resulting from applying a high voltage using such an optical deflecting device has also been known (Japanese Patent Application Publication No. 2014-2221, for example). The optical deflecting device according to Japanese Patent Application Publication No. 2014-2221 includes an optical waveguide, first and second upper electrodes, and first and second lower electrodes. A voltage having a polarity opposite to that applied between the first upper electrode and the first lower electrode is applied between the second upper electrode and the second lower electrode, and therefore, the electric field between the first upper electrode and the first lower electrode is electrically neutralized by the electric field between the second upper electrode and the second lower electrode, in the optical deflecting device. By suppressing the formation of a space charge field in the manner described above, a beam distortion can be suppressed.

An optical deflecting device is generally configured as an electro-optic deflector including an electro-optic crystal, and electrodes including a positive electrode and a negative electrode for applying a voltage to the electro-optic crystal. In use of such an electro-optic deflector, the beam becomes distorted when a voltage is applied by the electrodes. In a configuration in which it is difficult to include electrodes having a complex shape, as that disclosed in Japanese Patent Application Publication No. 2014-2221, or when a general electro-optic deflector is to be used, it has been difficult to suppress such a distortion in the laser beam coming out of the electro-optic deflector.

### SUMMARY

A laser beam deflecting device according to an aspect of the present invention includes an electro-optic deflector including an electro-optic crystal provided along an optical path of a laser beam, and electrodes for applying a voltage to the electro-optic crystal in a predetermined application direction; and a correction optical system provided downstream of the electro-optic deflector in a radiation direction of the laser beam to correct a beam diameter of the laser beam deflected in the application direction of the electrodes. The radiation direction of the laser beam without being deflected, with no voltage applied by the electrodes, serves as a reference optical axis. The correction optical system serves as an optical system for correcting the beam diameter of the laser beam, at least in the application direction, correspondingly to a distortion in the beam diameter that is dependent on a deflection angle. The deflection angle is formed by the laser beam deflected by the electro-optic deflector and the reference optical axis.

### BRIEF DESCRIPTION OF THE DRAWINGS

FIG. 1 is a schematic illustrating a laser beam machining apparatus according to a first embodiment.

FIG. 2 is a schematic illustrating a deflecting optical system and a focusing optical system according to the first embodiment.

FIG. 3 is an explanatory schematic related to a distortion and a correction of a laser beam diameter.

FIG. 4 is a graph of the beam diameter changing correspondingly to a deflection angle of the laser beam.

FIG. 5 is a graph of a curvature of a correction lens changed correspondingly to a deflection angle of the laser beam.

FIG. 6 is a flowchart related to designing of the correction lens according to the first embodiment.

FIG. 7 is a schematic illustrating a deflecting optical system and a focusing optical system according to a second embodiment.

FIG. 8 is a schematic illustrating a deflecting optical system and a focusing optical system according to a third embodiment.

### DETAILED DESCRIPTION

Some embodiments according to the present invention will now be explained in detail with reference to some drawings. However, these embodiments are not intended to limit the scope of the present invention in any way. Furthermore, the elements described in the embodiments include those that can be replaced by a person skilled in the art, or those that are substantially the same. Furthermore, the elements described below may be combined as appropriate, and when the embodiment is described in plurality, such embodiments may also be combined.

### First Embodiment

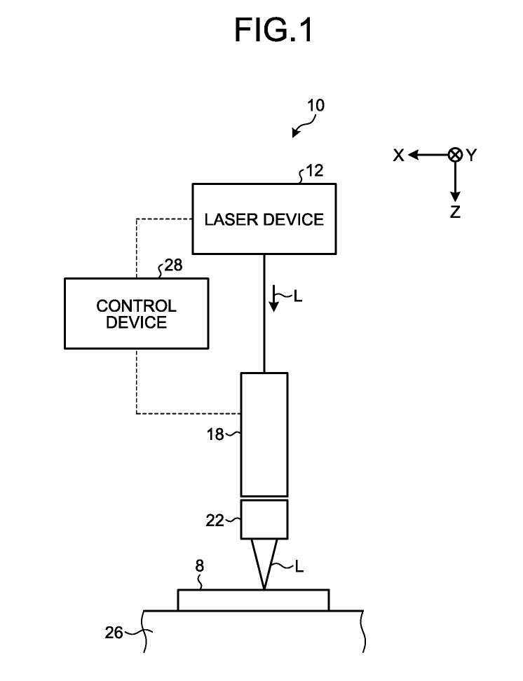

FIG. 1 is a schematic illustrating a laser beam machining apparatus according to a first embodiment. As illustrated in FIG. 1, this laser beam machining apparatus 10 according to the first embodiment is configured as an apparatus performing various types of machining, such as cutting and drilling, to a workpiece 8, by irradiating the workpiece 8 with a laser beam L. The type of machining is not limited to a particular type, but in the first embodiment, the laser beam machining apparatus 10 performs laser machining such as drilling or cutting.

As the workpiece 8, various types of materials may be used. For example, it is possible to use a member made of Inconel (registered trademark), Hastelloy (registered trademark), stainless steel, ceramic, steel, carbon steel, ceramics, silicone, titanium, tungsten, resin, plastic, glass, or the like. Furthermore, for the workpiece 8, it is also possible to use a fiber reinforced plastic, such as carbon fiber reinforced plastic (CFRP), glass fiber reinforced plastic (GFRP), glass mat reinforced thermoplastic (GMT), a ferroalloy other than a steel sheet, various types of metals such as aluminum alloy, and any other materials made of a composite material, for example.

The laser beam machining apparatus 10 includes a laser device 12, a deflecting optical system (laser beam deflecting device) 18, a focusing optical system 22, a support table 26, and a control device 28. In the first embodiment, the horizontal plane will be referred to as an XY plane including an X direction, and a Y direction that is orthogonal to the X direction. A vertical direction that is orthogonal to the horizontal plane will be referred to as a Z direction.

The laser device 12 is a device that outputs a laser beam L. As the laser device 12, it is possible to use a fiber laser that outputs a laser beam L using an optical fiber as a medium, or a short-pulse laser that outputs a short-pulse laser beam L. Examples of the fiber laser include a Fabry-Perot fiber laser and a ring fiber laser. Furthermore, the fiber laser may be the laser device 12 using either a continuous-wave operation mode or a pulsed-operation mode. As the fiber in the fiber laser device, silica glass with an addition of a rare-earth element (Er, Nd, Yb) may be used, for example. The short pulse herein means a pulse having a pulse width of 100 picosecond or shorter. As the laser generation source of the short-pulse laser output device, a titanium-sapphire laser may be used, for example. In the first embodiment, a short-pulse laser device capable of non-thermal machining is used. In other words, the laser beam machining apparatus 10 according to the first embodiment has a configuration in which a short-pulse laser device is used as the laser device 12.

The laser beam L output from such a laser device 12 is a laser beam for machining, and is a high-power laser beam having a power of 1 watt or higher. Specifically, the laser beam L has a frequency of 1 kilohertz to 1000 kilohertz or so, and a power of 100 watts to 10 kilowatts or so. The wavelength of the laser beam L is not limited to a particular wavelength range, but it is preferable to set the wavelength to a wavelength range suitable for a potassium tantalate niobate (KTN) crystal that is the electro-optic crystal provided to the deflecting optical system 18, which will be described later.

The deflecting optical system 18 is an optical system for deflecting the laser beam L output from the laser device 12. The deflecting optical system 18 is provided downstream of the laser device 12 in a radiation direction of the laser beam L. In the first embodiment, the deflecting optical system 18 is configured as an optical system by which the laser beam L is deflected in a uniaxial direction, and deflects the laser beam L in the X-axis direction, for example. In other words, the optical axis of the deflecting optical system 18 is established with reference to a direction extending along the Z direction as a reference optical axis, and the deflecting optical system 18 deflects the laser beam L in the X-axis direction on the orthogonal plane (XY plane) orthogonal to the reference optical axis.

The focusing optical system 22 is an optical system for focusing the laser beam L coming out of the deflecting optical system 18, and for irradiating the workpiece 8 with the focused laser beam L. The focusing optical system 22 includes a focusing lens 65. The focusing lens 65 focuses the deflected laser beam L on the workpiece 8.

The support table 26 supports the workpiece 8 at a predetermined position. The support table 26 may also be an XY stage for moving the workpiece 8 in the XY directions.

The control device 28 is connected to the laser device 12 and to each of the elements included in the deflecting optical system 18, and controls the operations of the laser beam machining apparatus 10, by controlling such elements. The control device 28 adjusts various conditions of the laser beam L output from the laser device 12, by controlling the laser device 12, for example. The control device 28 also deflects the laser beam L by controlling an X-axis electro-optic deflector 41, which will be described later, included in the deflecting optical system 18, for example.

The laser beam machining apparatus 10 having such a structure causes the laser device 12 to output a laser beam L, and guides the output laser beam L to the deflecting optical system 18. The laser beam machining apparatus 10 changes the position where the workpiece 8 is irradiated with the laser beam L, by causing the deflecting optical system 18 to deflect the laser beam L incident on the deflecting optical system 18, as appropriate. In the laser beam machining apparatus 10, the laser beam L coming out of the deflecting optical system 18 becomes incident on the focusing optical system 22, and the workpiece 8 is irradiated with the focused laser beam L.

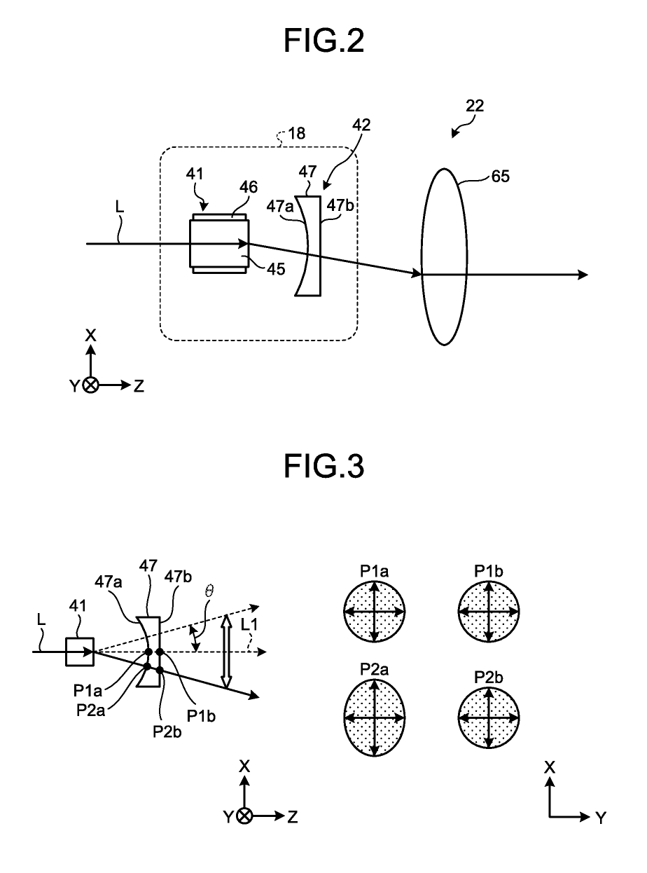

FIG. 2 is a schematic illustrating the deflecting optical system and the focusing optical system according to the first embodiment. As illustrated in FIG. 2, the deflecting optical system 18 includes an X-axis electro-optic deflector 41 and an X-axis correction optical system 42.

The X-axis electro-optic deflector 41 deflects the laser beam L in the X-axis direction with respect to the reference optical axis. The X-axis electro-optic deflector 41 includes an electro-optic crystal 45, and a pair of electrodes 46 provided facing each other in the X-axis direction, with the electro-optic crystal 45 interposed therebetween. As the electro-optic crystal 45, a KTN crystal is used, for example, and is provided along the optical path of the laser beam L. The size of the KTN crystal is small, e.g., 10 millimeters or so. This X-axis electro-optic deflector 41 deflects the laser beam L in the X-axis direction by changing the refractive index of the electro-optic crystal 45, by causing the pair of electrodes 46 to apply a voltage to the electro-optic crystal 45 in the X-axis direction.

The X-axis correction optical system 42 is configured to correct the beam diameter of the laser beam L deflected by the X-axis electro-optic deflector 41. The X-axis correction optical system 42 is a transmissive optical system including a correction lens 47. Used as the correction lens 47 is an aspherical cylindrical lens that is a plano-concave lens. In the first embodiment, the X-axis correction optical system 42 is explained to be a transmissive optical system, but, without limitation to this configuration, the X-axis correction optical system 42 may be a reflective optical system. Before explaining the correction lens 47 specifically, the beam diameter of the laser beam L deflected by the X-axis electro-optic deflector 41 will now be explained with reference to FIG. 3.

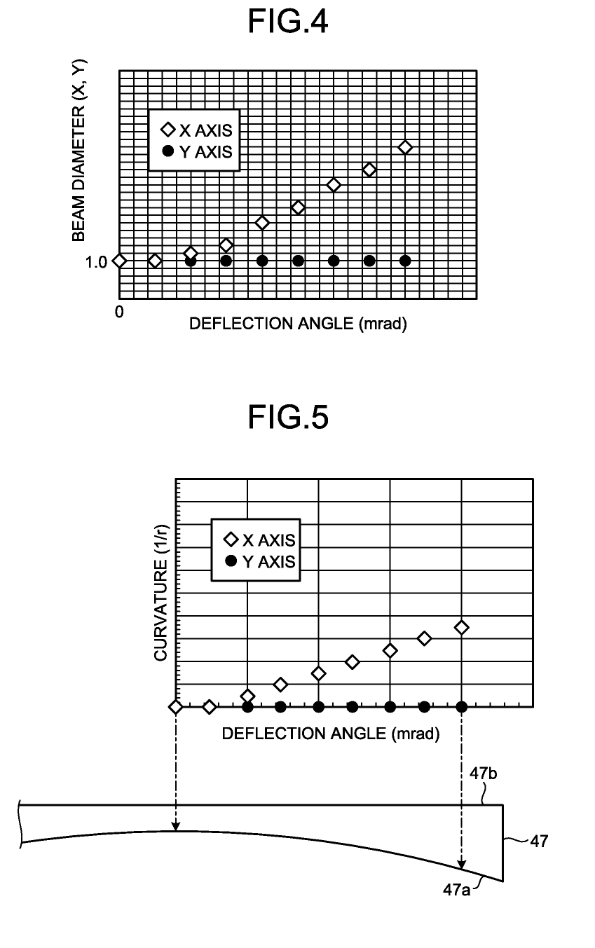

FIG. 3 is an explanatory schematic related to a distortion and a correction of the beam diameter of the laser beam. FIG. 4 is a graph of the beam diameter changing correspondingly to the deflection angle of the laser beam. As illustrated in FIG. 3, an exit angle of the laser beam L deflected by the X-axis electro-optic deflector 41, coming out of the X-axis electro-optic deflector 41, is deflected by a deflection angle θ with respect to a reference optical axis L1. This deflection angle θ is an angle formed by the reference optical axis L1 and the deflected laser beam L, and is greater when a higher voltage is applied by the electrodes 46.

In FIG. 4, the vertical axis represents the laser beam diameter (X, Y), and the horizontal axis represents the deflection angle (mrad). As illustrated in FIGS. 3 and 4, the laser beam L travelling along the reference optical axis L1 at a deflection angle θ of zero without being deflected by the X-axis electro-optic deflector 41, that is, the laser beam L not applied with any voltage by the electrodes 46 in the X-axis electro-optic deflector 41, has a circular beam diameter without any distortion, before the laser beam becomes incident on the correction lens 47 (at a point P1a). In other words, in the beam diameter of the laser beam L at the point P1a, the ratio of a diameter X in the X-axis direction with respect to a diameter Y in the Y-axis direction is such that the diameter X and the diameter Y are equal, and this beam diameter serves as a reference beam diameter where the diameter X/the diameter Y=1.0 is established. Therefore, the laser beam L at the point P1a is not corrected by the correction lens 47, and the beam diameter of the laser beam L coming out of the correction lens 47 (at a point P1b) still has a circular shape without any distortion. Therefore, in FIG. 4, because there is no change in the diameter X in the X-axis direction when the deflection angle θ is 0, the diameter X at the point P1a/the diameter X at the point P1b is 1.0. In the same manner, because there is no change in the diameter Y in the Y-axis direction when the deflection angle θ is 0, the diameter Y at the point P1a/the diameter Y at the point P1b is 1.0.

By contrast, as illustrated in FIGS. 3 and 4, the laser beam L deflected by the X-axis electro-optic deflector 41 by a predetermined deflection angle θ, that is, the laser beam L applied with a voltage by the electrodes 46 included in the X-axis electro-optic deflector 41 has an elliptical beam diameter that is elongated in the X-axis direction, for example, before the laser beam L becomes incident on the correction lens 47 (at a point P2a). In other words, in the beam diameter of the laser beam L at the point P2a, the diameter X in the X-axis direction is longer than the diameter Y in the Y-axis direction, and therefore, the ratio of the diameter X with respect to the diameter Y is more than 1.0. Therefore, the laser beam L at the point P2a is corrected with the correction lens 47, so that the beam diameter comes to have a circular shape without any distortion, after coming out of the correction lens 47 (at a point P2b). In FIG. 4, when the deflection angle θ becomes increased, the diameter X in the X-axis direction becomes elongated. Therefore, the ratio of the diameter X at the point P2a with respect to the diameter X at the point P2b is greater than 1.0. By contrast, the diameter Y in the Y-axis direction remains unchanged even when the deflection angle θ becomes increased. Therefore, the ratio of the diameter Y at the point P2a with respect to the diameter Y at the point P2b is 1.0.

The correction lens 47 will now be explained specifically with reference to FIG. 5. The correction lens 47 is a lens configured to correct the beam diameter of the laser beam L correspondingly to a distortion that is dependent on the deflection angle θ, in the direction of the voltage application of the electrodes 46 (the X-axis direction). As illustrated in FIG. 4, when the deflection angle θ becomes increased, the beam diameter of the laser beam L coming out of the electro-optic deflector becomes enlarged more in the X-axis direction. Therefore, the correction lens 47 is provided as a lens in which the amount of correction applied to the beam diameter in the X-axis direction is increased when the deflection angle θ is increased, so that the beam diameter is brought to the reference beam diameter.

The correction lens 47 is a plano-concave lens having an incident surface 47a that is concave on the incident side, and an outgoing surface 47b that is flat on the outgoing side. Because the correction lens 47 is an aspherical cylindrical lens, the incident surface 47a has a curved surface where the curvature changes in the X-axis direction, and where the curvature remains constant in the Y-axis direction.

The curvature for correcting the beam diameter of the laser beam L will now be explained. Denoting the beam diameter as d, denoting a focal length as f, denoting the wavelength as λ, denoting the radius of the incident beam as D, and denoting the beam quality as M, the beam diameter d is expressed by Equation (1) below:

d=f×λ×M²/(π×D) (1)

The focal length f of the plano-concave correction lens 47 can be expressed by Equation (2) below, denoting the curvature radius of the incident surface 47a as r, and the refractive index of the lens material as n:

f=r/(1−n) (2)

Substituting f in Equation (1) with Equation (2), d is obtained from Equation (3) below:

d=r×λ×M²/{(π×D)×(1−n)} (3)

Assuming that the beam diameter d of the laser beam L becomes enlarged to a beam diameter d′ (=α×d) as a result of deflection, the beam diameter d′ can be corrected to the beam diameter d by setting the curvature radius r to a curvature radius r′ (=r/α). In other words, when the beam diameter d becomes enlarged, the beam diameter d can be corrected by reducing the curvature radius r. To put it another way, because the curvature of the incident surface 47a is the inverse of the curvature radius r, when the beam diameter d becomes enlarged, the beam diameter d can be corrected by increasing the curvature (1/r) of the incident surface 47a.

Because the beam diameter d of the laser beam L in the X-axis direction becomes enlarged as the deflection angle θ becomes greater, as illustrated in FIG. 4, the incident surface 47a of the correction lens 47 has a flat parallel surface along the reference optical axis L1 (a surface orthogonal to the reference optical axis L1), and the curvature of the incident surface 47a is increased as the deflection angle θ is increased, as illustrated in FIG. 5. The part having the flat parallel surface along the reference optical axis L1 is provided at the center of the correction lens 47.

When a laser beam L coming out of the X-axis electro-optic deflector 41 becomes incident on such a correction lens 47, the correction lens 47 corrects the beam diameter having been distorted, as a result of being deflected in the X-axis direction, to the reference beam diameter.

A distance between the X-axis electro-optic deflector 41 and the X-axis correction optical system 42 along the optical path of the laser beam L is set to a range equal to or more than 2 millimeters and equal to and less than 100 millimeters. It is more preferable for the distance between the X-axis electro-optic deflector 41 and the X-axis correction optical system 42 (the correction lens 47) to be equal to or more than 2 millimeters, and equal to and less than 50 millimeters. The appropriate distance depends on the characteristics of the laser beam L in use (such as the power, the pulse width, the peak power, and the beam diameter), and the characteristics of the deflection in use (the deflection speed, the deflection angle), and is generally set within the range mentioned above.

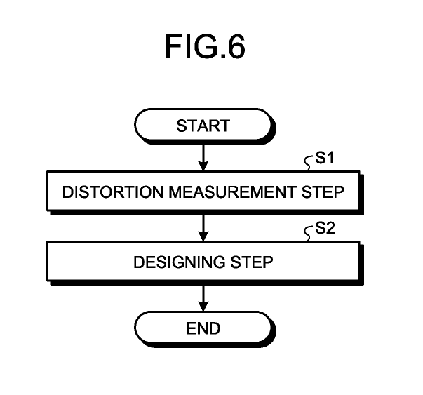

A method for designing the correction lens 47 will now be explained with reference to FIG. 6. FIG. 6 is a flowchart related to designing of the correction lens according to the first embodiment. To begin with, before the correction lens 47 is designed, the beam diameter d in the X-axis direction is measured correspondingly to the deflection angle θ of the laser beam L coming out of the X-axis electro-optic deflector 41 (Step S1: distortion measurement step). At this distortion measurement step S1, a measurement instrument for measuring the beam diameter d in the X-axis direction is arranged at a predetermined position along the optical path of the laser beam L, downstream of the X-axis electro-optic deflector 41 in the radiation direction of the laser beam L.

The curvature of the incident surface 47a on the correction lens 47 is then designed in such a manner that the beam diameter d in the X-axis direction, measured at the distortion measurement step S1 correspondingly to the deflection angle θ, is brought to the reference beam diameter (Step S2: designing step). The correction lens 47 is then manufactured based on the curvature designed at the designing step S2.

As described above, according to the first embodiment, even when the laser beam L is deflected by the X-axis electro-optic deflector 41, it is possible to correct a distortion in the beam diameter d of the laser beam L deflected by the X-axis correction optical system 42 in the X-axis direction. Therefore, it is possible to suppress a distortion in the laser beam L deflected by the X-axis electro-optic deflector 41.

Furthermore, according to the first embodiment, it is possible to correct the X-axis direction beam diameter d of the laser beam L, which becomes more distorted when the deflection angle θ becomes greater, appropriately, using the correction lens 47 that is an aspherical lens. In other words, when the deflection angle θ is zero, the beam diameter d in the X-axis direction is not corrected. Therefore, the beam diameter d in the X-axis direction when the deflection angle θ is zero is used as the reference beam diameter. By increasing the amount of correction as the deflection angle θ is increased so that the beam diameter d of the laser beam L in the X-axis direction is brought to the reference beam diameter, the beam diameter d of the laser beam L in the X-axis direction can be corrected appropriately. At this time, by using the correction lens 47 that is an aspherical lens in the correction, the beam diameter d of the laser beam L in the X-axis direction can be corrected using a simple structure.

Furthermore, according to the first embodiment, it is possible to correct the X-axis direction beam diameter d of the laser beam L, which becomes enlarged when the deflection angle θ becomes increased, appropriately, using the correction lens 47 that is a plano-concave lens.

Furthermore, according to the first embodiment, it is possible to correct a distortion in the beam diameter d of the laser beam L in the X-axis direction, the distortion being introduced in the direction in which the voltage is applied by the electrodes 46, appropriately, using the correction lens 47 that is a cylindrical lens.

Furthermore, according to the first embodiment, it is possible to set the distance between the X-axis electro-optic deflector 41 and the X-axis correction optical system 42 to an appropriate distance, when the beam diameter of the deflected laser beam in the X-axis direction is to be corrected.

Furthermore, according to the first embodiment, the workpiece 8 can be irradiated with a laser beam L having an appropriate beam diameter even after the deflection via the deflecting optical system 18. Therefore, laser machining of the workpiece 8 can be performed appropriately.

Furthermore, according to the first embodiment, the correction lens 4 for suitably correcting the laser beam L, the beam diameter d of which in the X-axis direction becomes distorted by being deflected by the X-axis electro-optic deflector 41, can be designed appropriately.

In the first embodiment, an aspherical cylindrical lens is used as the correction lens 47, but the configuration of the lens is not limited to this particular configuration. For example, as the correction lens 47, it is possible to use an aspherical lens having an incident surface 47a with a curvature for correcting the beam diameter d correspondingly to a distortion in the beam diameter d, in a direction orthogonal to the voltage application direction as well as in the voltage application direction. With such a configuration, because a distortion in the beam diameter d can be corrected two dimensionally on the incident surface 47a of the correction lens 47, the beam diameter d can be corrected more favorably.

### Second Embodiment

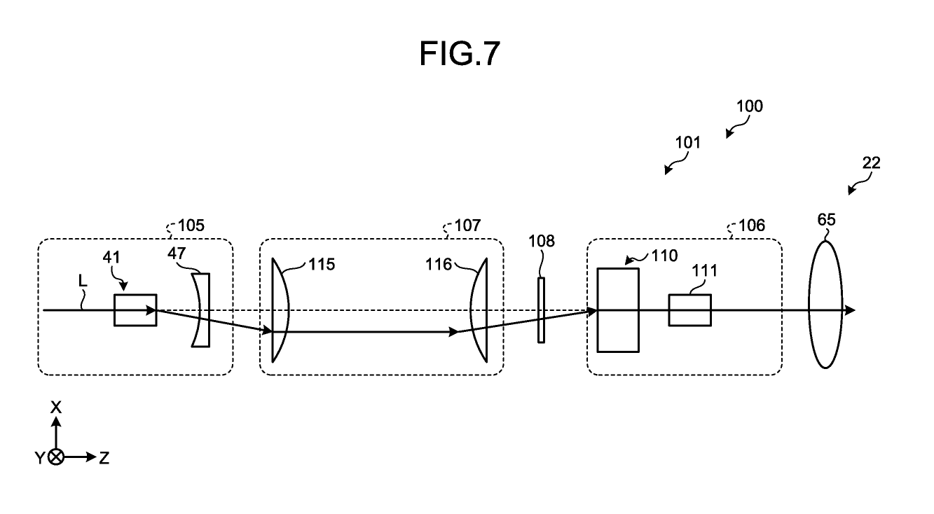

A laser beam machining apparatus 100 according to a second embodiment will now be explained with reference to FIG. 7. In the second embodiment, only the parts that are different from those in the first embodiment will be explained to avoid redundant explanations, and the elements that are the same as those in the first embodiment will be explained by using the same reference signs. FIG. 7 is a schematic illustrating a deflecting optical system and a focusing optical system according to the second embodiment.

In the laser beam machining apparatus 100 according to the second embodiment, a deflecting optical system 101 is an optical system by which the laser beam L is deflected in biaxial directions, and deflects the laser beam L in the X-axis direction and the Y-axis direction, for example. In other words, the deflecting optical system 101 deflects the laser beam L in the X-axis direction and the Y-axis direction on the orthogonal plane that is orthogonal to the reference optical axis L1 (XY plane).

As illustrated in FIG. 7, the deflecting optical system 101 includes an X-axis deflecting optical system 105, a Y-axis deflecting optical system 106, a relay optical system 107, and a waveplate 108. The X-axis deflecting optical system 105 includes the X-axis electro-optic deflector 41 and the X-axis correction optical system 42 (correction lens 47), in the same manner as the deflecting optical system 18 according to the first embodiment. The explanation of the X-axis deflecting optical system 105 will be omitted, because the X-axis deflecting optical system 105 is the same as the deflecting optical system 18 according to the first embodiment.

The Y-axis deflecting optical system 106 includes a Y-axis electro-optic deflector 110 and a Y-axis correction optical system 111. The Y-axis deflecting optical system 106 has the same configuration as the X-axis deflecting optical system 105, but with the X-axis direction changed to the Y-axis direction. Because the Y-axis deflecting optical system 106 has almost the same configuration as that of the X-axis deflecting optical system 105, the explanation of the Y-axis deflecting optical system 106 will be omitted.

The relay optical system 107 is an optical system that is provided between the X-axis deflecting optical system 105 and the Y-axis deflecting optical system 106, and guides the laser beam L coming out of the X-axis deflecting optical system 105 to the Y-axis deflecting optical system 106. The relay optical system 107 includes a plurality of relay lenses 115, 116, and forms an image of the laser beam L coming out of the X-axis electro-optic deflector 41 on the Y-axis electro-optic deflector 110.

The waveplate 108 is a ½ waveplate, and changes the polarization direction of the laser beam L coming out of the X-axis deflecting optical system 105 from the X-axis direction to the Y-axis direction, so that the laser beam L linearly polarized in the Y-axis direction becomes incident on the Y-axis deflecting optical system 106.

As described above, according to the second embodiment, the relay optical system 107 can be provided between the X-axis deflecting optical system 105 and the Y-axis deflecting optical system 106. Therefore, it is possible to move the laser beam L in the XY plane in machining the workpiece 8. With the X-axis electro-optic deflector 41 and the Y-axis electro-optic deflector 110, it is possible to deflect the laser beam L in the X-axis direction and the Y-axis direction, and the beam diameter of the laser beam L can be corrected using the X-axis correction optical system 42 and the Y-axis correction optical system 111.

### Third Embodiment

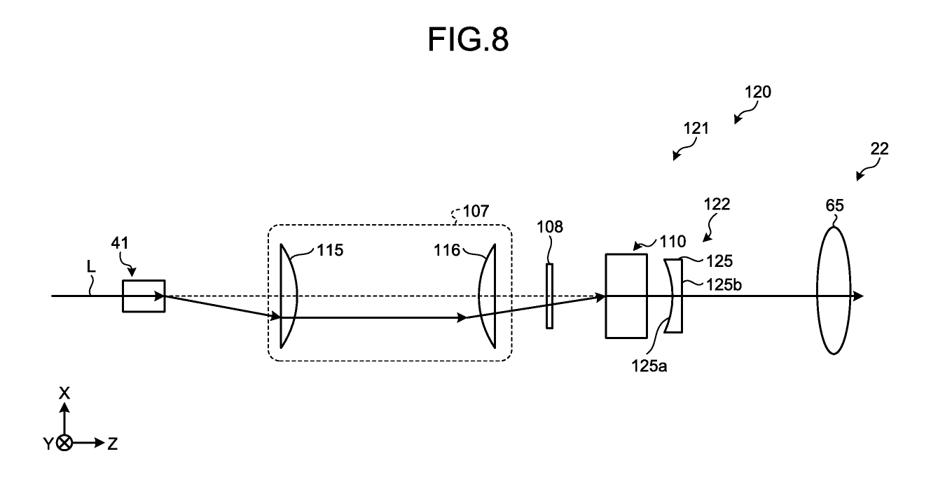

A laser beam machining apparatus 120 according to a third embodiment will now be explained with reference to FIG. 8. In the third embodiment, too, the parts that are different from those in the first embodiment and the second embodiment will be explained to avoid redundant explanations, and the elements that are the same as those in the first embodiment and the second embodiment will be explained by using the same reference signs. FIG. 8 is a schematic illustrating a deflecting optical system and a focusing optical system according to the third embodiment.

In the laser beam machining apparatus 120 according to the third embodiment, a deflecting optical system 121 is an optical system by which the laser beam L is deflected in the biaxial directions, and one correction optical system is used to correct the beam diameter of the laser beam L deflected in the X-axis direction and the Y-axis direction.

As illustrated in FIG. 8, the deflecting optical system 121 includes the X-axis electro-optic deflector 41, the Y-axis electro-optic deflector 110, the relay optical system 107, the waveplate 108, and a correction optical system 122. The X-axis electro-optic deflector 41 is the same as that according to the first embodiment. The Y-axis electro-optic deflector 110 is the same as that according to the second embodiment, and is equivalent to the X-axis electro-optic deflector 41 with the X-axis direction changed to the Y-axis direction. Therefore, the explanations of these elements are omitted. The relay optical system 107 and the waveplate 108 are also the same as those according to the second embodiment, and therefore, the explanations thereof will be omitted.

The correction optical system 122 corrects the beam diameter of the laser beam L deflected by the X-axis electro-optic deflector 41 and the Y-axis electro-optic deflector 110 in the X-axis direction and the Y-axis direction, respectively, in the X-axis direction and the Y-axis direction, respectively. The correction optical system 122 is configured as a transmissive optical system including a correction lens 125. As the correction lens 125, an aspherical lens that is a plano-concave lens is used.

The correction lens 125 is a plano-concave lens having an incident surface 125a that is concave on the incident side, and an outgoing surface 125b that is flat on the outgoing side. The correction lens 125 is an aspherical lens, and therefore, the incident surface 125a has a curved surface where the curvature changes in the X-axis direction and the Y-axis direction.

When the laser beam L coming out of the X-axis electro-optic deflector 41 and passed through the Y-axis electro-optic deflector 110 becomes incident on the correction lens 125, the correction lens 125 corrects the beam diameter distorted by being deflected in the X-axis direction and the Y-axis direction to the reference beam diameter.

As described above, according to the third embodiment, the relay optical system 107 can be provided between the X-axis deflecting optical system 105 and the Y-axis deflecting optical system 106. Therefore, it is possible to move the laser beam L on the XY plane in machining the workpiece 8. With the X-axis electro-optic deflector 41 and the Y-axis electro-optic deflector 110, the laser beam L can be deflected in the X-axis direction and the Y-axis direction, respectively, and the beam diameter of the laser beam L can be corrected using the X-axis correction optical system 42 and the Y-axis correction optical system 111.

A laser beam deflecting device according to an aspect of the present invention includes an electro-optic deflector including an electro-optic crystal provided along an optical path of a laser beam, and electrodes for applying a voltage to the electro-optic crystal in a predetermined application direction; and a correction optical system provided downstream of the electro-optic deflector in a radiation direction of the laser beam to correct a beam diameter of the laser beam deflected in the application direction of the electrodes. The radiation direction of the laser beam without being deflected, with no voltage applied by the electrodes, serves as a reference optical axis. The correction optical system serves as an optical system for correcting the beam diameter of the laser beam, at least in the application direction, correspondingly to a distortion in the beam diameter that is dependent on a deflection angle. The deflection angle is formed by the laser beam deflected by the electro-optic deflector and the reference optical axis.

With such a configuration, even when the laser beam is deflected by the electro-optic deflector, a distortion in the beam diameter of the laser beam can be corrected with the correction optical system. Therefore, a distortion in the laser beam deflected by the electro-optic deflector can be suppressed.

It is preferable that the correction optical system is an aspherical lens in which in the application direction, an amount of correction applied to the beam diameter is zero with a deflection angle of zero and the amount of correction is increased with increasing the deflection angle so that the beam diameter is brought to a reference beam diameter, the reference beam diameter being a beam diameter for a deflection angle of zero.

With such a configuration, it is possible to correct the beam diameter of the laser beam, which becomes distorted more as the deflection angle becomes increased, appropriately, using an aspheric lens. In other words, the beam diameter is not corrected when the deflection angle is zero. Therefore, the beam diameter resultant of a deflection angle of zero is used as a reference beam diameter. By increasing the amount of correction as the deflection angle is increased so that the beam diameter of the laser beam is brought to the reference beam diameter, the laser beam diameter can be corrected appropriately. At this time, by using an aspheric lens in the correction, the laser beam diameter can be corrected using a simple structure.

It is preferable that the beam diameter of the laser beam coming out of the electro-optic deflector is increased with increasing the deflection angle, the aspherical lens is a plano-concave lens having an incident surface that is concave on an incident side, and an outgoing surface that is flat on an outgoing side, and a curvature of the incident surface is zero at a position where the laser beam is incident with a deflection angle of zero, and is increased at a position where the laser beam is incident with increasing the deflection angle.

With such a configuration, it is possible to correct the laser beam diameter, which becomes increased as the deflection angle becomes increased, appropriately, using a plano-concave lens.

It is preferable that the aspherical lens is a cylindrical lens having a constant curvature in a direction orthogonal to the radiation direction and to the application direction, on the incident surface.

With such a configuration, a distortion in the laser beam diameter in the application direction can be corrected appropriately using a cylindrical lens.

It is preferable that the aspherical lens is a lens having a curvature correcting the beam diameter correspondingly to a distortion of the beam diameter, in a direction orthogonal to the radiation direction and to the application direction, on the incident surface.

With such a configuration, the laser beam diameter can be corrected in a direction orthogonal to the application direction as well as in the application direction on the incident surface. Therefore, a distortion in the beam diameter can be corrected two dimensionally on the incident surface, so that the beam diameter can be corrected more favorably.

It is preferable that a distance between the electro-optic deflector and the correction optical system along an optical path of the laser beam is within a range of 2 millimeters to 100 millimeters.

With such a configuration, when the beam diameter of the deflected laser is to be corrected, the distance between the electro-optic deflector and the correction optical system can be set to an appropriate distance. It is preferable for the distance between the electro-optic deflector and the correction optical system to be equal to or more than 2 millimeters and equal to and less than 50 millimeters. An appropriate distance is dependent on the characteristics of the laser beam in use (e.g., the power, the pulse width, the peak power, and the beam diameter), and the characteristics of the deflection in use (the deflection speed, the deflection angle), and is generally set within the range mentioned above.

A laser beam machining apparatus according to the present invention includes a laser device configured to output a laser beam toward a workpiece; the laser beam deflecting device described above on which the laser beam output from the laser device becomes incident; and a focusing optical system configured to focus the laser beam coming out of the laser beam deflecting device, on the workpiece.

With such a configuration, the workpiece can be irradiated with a laser beam deflected by the laser beam deflecting device and having an appropriate beam diameter. Therefore, laser machining of the workpiece can be performed appropriately.

It is preferable that the laser beam deflecting device includes an X-axis deflecting optical system by which the laser beam is deflected in an X-axis direction, and a Y-axis deflecting optical system by which the laser beam is deflected in a Y-axis direction, on a plane that is orthogonal to the radiation direction of the laser beam.

With such a configuration, the laser beam can be moved on a two dimensional surface in the laser machining of the workpiece. With the X-axis deflecting optical system, correction of the beam diameter as well as deflection of the laser beam in the X-axis direction can be achieved. With the Y-axis deflecting optical system, correction of the beam diameter as well as deflection of the laser beam in the Y-axis direction can be achieved.

It is preferable that the electro-optic deflector included in the laser beam deflecting device includes an X-axis electro-optic deflector for deflecting the laser beam in an X-axis direction, and a Y-axis electro-optic deflector for deflecting the laser beam in a Y-axis direction, and the correction optical system is provided downstream of the X-axis electro-optic deflector and the Y-axis electro-optic deflector in the radiation direction of the laser beam.

With such a configuration, the laser beam can be moved on a two dimensional surface in the laser machining of the workpiece. With the X-axis electro-optic deflector and the Y-axis electro-optic deflector, deflections of the laser beam in the X-axis direction and the Y-axis direction can be achieved, respectively, and correction of the laser beam can be achieved with the correction optical system.

While certain embodiments have been described, these embodiments are not intended to limit the scope of the inventions. The components in the embodiments include ones that a person skilled in the art can easily conceive of, ones that are substantially the same, or ones that fall within their equivalents. Furthermore, various omissions, substitutions, combinations, and changes may be made as appropriate to configurations of the components disclosed in the embodiments without departing from the spirit of the inventions.

What is claimed is:

1. A laser beam deflecting device comprising:
an electro-optic deflector including an electro-optic crystal provided along an optical path of a laser beam, and electrodes for applying a voltage to the electro-optic crystal in a predetermined application direction; and
a correction optical system provided downstream of the electro-optic deflector in a radiation direction of the laser beam to correct a beam diameter of the laser beam deflected in the application direction of the electrodes, wherein
the radiation direction of the laser beam without being deflected, with no voltage applied by the electrodes, serves as a reference optical axis, and
the correction optical system serves as an optical system for correcting the beam diameter of the laser beam, at least in the application direction, correspondingly to a distortion in the beam diameter that is dependent on a deflection angle, the deflection angle being formed by the laser beam deflected by the electro-optic deflector and the reference optical axis.

2. The laser beam deflecting device according to claim 1, wherein
the correction optical system is an aspherical lens in which in the application direction, an amount of correction applied to the beam diameter is zero with a deflection angle of zero and the amount of correction is increased with increasing the deflection angle so that the beam diameter is brought to a reference beam diameter, the reference beam diameter being a beam diameter for a deflection angle of zero.

3. The laser beam deflecting device according to claim 2, wherein
the beam diameter of the laser beam coming out of the electro-optic deflector is increased with increasing the deflection angle,
the aspherical lens is a plano-concave lens having an incident surface that is concave on an incident side, and an outgoing surface that is flat on an outgoing side, and
a curvature of the incident surface is zero at a position where the laser beam is incident with a deflection angle of zero, and is increased at a position where the laser beam is incident with increasing the deflection angle.

4. The laser beam deflecting device according to claim 3, wherein the aspherical lens is a cylindrical lens having a constant curvature in a direction orthogonal to the radiation direction and to the application direction, on the incident surface.

5. The laser beam deflecting device according to claim 3, wherein the aspherical lens is a lens having a curvature correcting the beam diameter correspondingly to a distortion of the beam diameter, in a direction orthogonal to the radiation direction and to the application direction, on the incident surface.

6. The laser beam deflecting device according to claim 1, wherein a distance between the electro-optic deflector and the correction optical system along an optical path of the laser beam is within a range of 2 millimeters to 100 millimeters.

7. A laser beam machining apparatus comprising:
a laser device configured to output a laser beam toward a workpiece;
the laser beam deflecting device according to claim 1 on which the laser beam output from the laser device becomes incident; and
a focusing optical system configured to focus the laser beam coming out of the laser beam deflecting device, on the workpiece.

8. The laser beam machining apparatus according to claim 7, wherein the laser beam deflecting device includes an X-axis deflecting optical system by which the laser beam is deflected in an X-axis direction, and a Y-axis deflecting optical system by which the laser beam is deflected in a Y-axis direction, on a plane that is orthogonal to the radiation direction of the laser beam.

9. The laser beam machining apparatus according to claim 7, wherein
the electro-optic deflector included in the laser beam deflecting device includes an X-axis electro-optic deflector for deflecting the laser beam in an X-axis direction, and a Y-axis electro-optic deflector for deflecting the laser beam in a Y-axis direction, and
the correction optical system is provided downstream of the X-axis electro-optic deflector and the Y-axis electro-optic deflector in the radiation direction of the laser beam.
